(19) United States
(12) Patent Application Publication
(10) Pub. No.: US 2007/0174072 A1
(43) Pub. Date: Jul. 26, 2007

(54) Method, system and computer program for displaying an image of framed artwork

(75) Inventor: Jeffrey D. King, Wilmington, NC (US)

Correspondence Address: WILLIAM J. MASON;MACCORD MASON PLLC, POST OFFICE BOX 1489, WRIGHTSVILLE BEACH, NC, 28480, US

(73) Assignee: Specialty Software Systems, Inc.

(21) Appl. No.: 11/336,370

(22) Filed: Jan. 20, 2006

(51) Int. Cl. G06Q 99/00

(52) U.S. Cl. 705/1

(57) ABSTRACT

A computer generated representation of artwork surrounded by framing components is created by the steps of positioning the artwork and framing components at designated locations on a template, taking a digital photograph of the artwork and components, transferring the photograph into computer memory, identifying the components in the photograph from their features, generating images of component surrounds from the stored photograph, and displaying an electronic representation of the artwork within the component surrounds. The condition of the artwork may also be recorded by displaying an image of the stored artwork photograph on a monitor along with condition indicating icons, positioning the icons on the artwork image to indicate the location of defects, and storing with image with positioned icons.

### BACKGROUND OF THE INVENTION

(1) Field of the Invention

The present invention relates to a method, system and computer program product for use in displaying a computer generated image of artwork surrounded by framing components, and in particular to the generation of the image from a photographic image of preselected framing components.

(2) Description of the Prior Art

Artwork, the term as used herein including paintings, prints, drawings, photographs, and the like, is often taken to a professional framing shop for framing. At the shop, the framer and customer select framing components that will provide a visually pleasing setting for the artwork. Framing components normally include at least one mat that immediately surrounds the artwork while slightly overlapping the periphery of the artwork, and moulding that surrounds the outer periphery of the mat while slightly overlapping the mat, with the outer periphery of the moulding forming the outer periphery of the framed artwork.

Other framing components can also be used. Instead of a single mat, a plurality of mats can be stacked together, with the inner edge of each mat being exposed beyond the inner periphery of the mat immediately above it. The term “reveal” is used to identify the exposed part of the lower mat or mats. If two mats are used the mats will be identified as the top mat and the bottom mat, with the bottom mat having a visible reveal beyond the inner periphery of the top mat.

In addition to one or more mats and the moulding, the framed artwork may also include other framing components, such as a fillet, which is a small piece of inner moulding positioned around the inner periphery of the moulding or one or more of the mats. A mat may also include surface embellishments, such as one or more V-shaped grooves cut into the mat's upper surface.

Normally, a framing shop will stock a large selection of framing component samples. Instead of stocking complete mats and mouldings, these samples, for reasons of space and cost, are normally stocked as “corner samples”, i.e., V-shaped or L-shaped segments of one corner of a component with partial, normally equal length, horizontal and vertical arms.

Corner samples of potentially suitable framing components are placed at one corner of the artwork on a horizontal surface, or held by the framer for viewing by the customer. Positioning the artwork and framing components adjacent to each other is helpful in visualizing the textural and three-dimensional aspects of the combination. However, since the corner samples only extend around a part of the artwork, it is often difficult for the customer to visualize the appearance of the final framed artwork.

Several companies have attempted to address this problem by offering software known as framing software to framing shops. Many companies offering framing software can be found on the Internet. An example of one type of framing software is found in U.S. Pat. No. 5,870,771 to Oberg, issued Feb. 9, 1999.

In using this first type of prior art framing software, the customer or framer is able to create electronically generated images of the artwork to be framed surrounded by selected framing components by using a graphic user interface or GUI environment. As used herein, the term “Graphical User Interface (GUI) environment” refers to an environment characterized by using a pointing device, such as a mouse, to manipulate a pointer, such as a cursor, over relevant visual graphics on a computer display and causing action by selection of the graphic, such as by clicking on a mouse button. Application programs are represented, either directly or indirectly by icons that when selected cause the application program to “launch” or begin running. Examples include the Microsoft Windows environment or the X Windows/Motif environment for UNIX-based systems.

The artwork image and images of a plurality of framing components are stored in memory. The software displays images of artwork and segments of the framing components on a monitor, enabling the user to select desired framing components. Upon selection of the components, the software generates an image of the artwork surrounded by the selected components.

In a second type of commercially available framing software, preselected framing components are stacked at one corner of the artwork in the positions they would be in if the artwork was framed with the components. A photograph is then taken of the artwork and stacked components. The user then manually selects a rectangular segment of the combined components and the software program generates surrounds of the components from the selected segment. The artwork with surrounds is then displayed on the computer monitor.

In a third type of software, preselected components are placed at random on a surface and a photograph of the components is stored. The user then manually selects a rectangular segment of each of the components and the selected segments are used by the software program to generate surrounds.

The software may also include other refinements. For example, the background behind the framed artwork can be changed to approximate the color of the wall upon which the artwork is to be mounted. The software can also calculate the price of the framed artwork based on stored information about the components and the dimension of the artwork, enabling the customer to immediately see the price of the selected combination.

While this prior art software is of considerable value in enabling the customer to visualize the appearance of the artwork as it will appear after framing, each type of software has its deficiencies. In using the first type of software, the often small graphic image does not enable the customer to adequately visualize the full-size relationship of the artwork and components or their textural and three-dimensional relationship. Many customers also want to “see” the actual moulding and mats, instead of a small graphical representation.

While the second and third types of software permit viewing of the actual framing components and viewing of a computer generated image of the artwork surrounded by the components, the dimensions of the framing components in the viewed image are limited with the second type of software since all of the components are selected together. In both of these types of software, the user is also required to manually select an area of the components, e.g., a rectangular segment or an area defined by selected points, for use in generating the images.

Therefore, there is a continuing need for a method, system and related software that will enable the customer to more fully visualize how artwork will appear after framing before undertaking the cost of having the artwork framed, while also avoiding the necessity of manually selecting segments of each component in preparation for surround generation.

### SUMMARY OF THE INVENTION

Generally, the present invention addresses this need by providing a method, system and related software that will enable a frame shop customer to combine their artwork with actual corner samples of framing components and, once a possible combination of framing components has been selected, view an image of the artwork surrounded by computer generated images of the selected framing components individually adjustable to the dimensions of the artwork. The invention further provides for identification and extraction of information regarding each of the framing components by the software without the need for user manual selection.

In the practice of the present method, the frame and customer view different combinations of moulding and mats with the artwork. Once a preferred combination has been selected, the artwork and chosen framing components are arranged at predetermined positions on a surface. The software program forming a part of the present invention will then be able to automatically determine what each of the components are from the component's features, which may include, for example, color, size, position on the surface, or combination of two or more features.

A photograph of the components is then taken with a digital camera attached to a computer or workstation. Using known image transfer software, the digital image is then transferred to a computer memory. The computer GUI may include a means for the user to activate the camera. It will be understood by one skilled in the art that references to storage of a photograph or a photographic image in fact refers to storage of image pixel values which determine the color and intensity of each pixel used to form the image. These pixel values are then used by a software program in accordance with stored instructions to populate a pixel array to display the stored image.

A typical computer or workstation will include components such as a bus for communicating information, and a processor coupled with the bus for processing information, random access memory, coupled to the bus for storing information and instructions to be executed by the processor. RAM also may be used for storing temporary variables or other intermediate information during execution of instructions by the processor, a read only memory coupled to the bus for storing static information and instructions for the processor, and a data storage device coupled to the bus for storing information and instructions. The data storage device may include a magnetic disk or optical disk and its corresponding disk drive can be coupled to the computer system. Also the system may be coupled via the bus to a display device for displaying information to a computer user. The computer system further includes a keyboard and a cursor control, such as a mouse.

Preferably, a template is provided with positioning guides for use in arranging the artwork and framing components on the template. For example, the template may include one area for placement of the artwork and another area for placement of the framing components. Alignment or positioning guides may be printed or displayed on the template surface to aid in positioning the artwork and components. For instance, a grid pattern of equidistant horizontal and vertical lines may be placed on the artwork area of the template so that the artwork can be aligned with the grid. A plurality of V-shaped chevrons may be placed on the component area, so that the V-shaped or L-shaped corner pieces can be aligned with the chevrons. Unless the software program is identifying the framing components by their locations on the template, any component can be aligned with either of the positioning guides.

The template may be, for example, a sheet of plastic, rubber, or other material that has the layout design printed on a planar surface. Preferably, the material is a self-healing material. The template can also include an additional calibration mark, i.e., a mark of a known dimension, for use in determining the dimensions of the artwork, or one of the positioning guides for the artwork or components can be used for this purpose.

A computer program product comprising a computer readable program embodied therein installed in the computer memory and readable by the processor extracts information from the images of each of the framing components in the stored photograph data and generates a representation of the artwork surrounded by the selected framing components on the computer monitor or other display means. As used herein, the term “computer program product” is used to generally refer to removable storage unit, a hard disk installed in hard disk drive, or a carrier wave or other signal carrying software over a communication path (wireless link or cable) to a communication interface. A computer useable medium can include magnetic media, optical media, or other recordable media, or media that transmits a carrier wave. These computer program products are means for providing software to the computer system.

Computer programs are stored in memory and, when executed, enable the computer system to perform the features of the present invention. In particular, the computer programs, when executed, enable the processor to perform the features of the present invention. Computer programs such as that described herein are typically distributed as part of a computer program product that has a computer useable media or medium containing the program code. Therefore, “media”, “medium”, “computer useable medium”, or “computer useable media”, as used herein, may include a diskette, a tape, a compact disc, an integrated circuit, a programmable logic array (PLA), a remote transmission over a communications circuit, a remote transmission over a wireless network such as a cellular network, or any other medium useable by computers with or without proper adapter interfaces. Note that examples of a computer useable medium include but are not limited to palpable physical media, such as a CD Rom, diskette, hard drive and the like, as well as other non-palpable physical media, such as a carrier signal, whether over wires or wireless, when the program is distributed electronically.

Although the enabling instructions might be “written on” a diskette or tape, “stored in” an integrated circuit or PLA, “carried over” a communications circuit or wireless network, it will be appreciated, that for purposes of the present invention described herein, the computer useable medium will be referred to as “bearing” the instructions, or the instructions (or software) will be referred to as being “on” the medium. Thus, software or instructions “on” a medium is intended to encompass the above and all equivalent ways in which the instructions or software is associated with a computer useable medium.

The computer program may perform several steps, not necessarily in the order described below, in generating this representation. First, the program performs the step of identifying the artwork and framing components from their placement on the template or from other features. The dimensions of the artwork and components are determined by comparing the dimensions of the calibration mark with the relative dimensions of the artwork and components.

The program also performs the step of determining the desired component dimensions for display from default settings or an algorithm based on the artwork dimensions. These dimensions can be later changed by user input. The computer program then performs the step of extracting image information regarding the artwork and components from the photographic image, and then performs the step of generating surrounds of each of the components. Finally, the program performs the step of displaying the combined image of the artwork and components surrounds for viewing by the customer.

Additional steps may be performed to ensure an accurate representation of the artwork and components. For example, the program can perform the step of checking the artwork for squareness, e.g., by measuring the diagonals of the artwork and adjusting the artwork image if necessary. The program can also perform the step of checking the components on the template for proper alignment, e.g., by known machine vision techniques such as edge detection. If a component is out of alignment, the program can perform the step of deskewing to present a properly aligned image. In displaying the framed artwork image, the program can perform the step of changing the background in response to user input. The program can also select colors from the artwork and provide recommended mat colors based on the selected colors.

The condition of the photographed artwork can also be recorded. To do so, the artwork is displayed along with a plurality of icons identifying possible defects in the artwork, e.g., stains, tears, etc. These icons can then be moved, e.g., by a mouse over to the locations of the defects on the artwork. The icons can be unique for a given condition, e.g., a “stain” icon, or the icons can have an alphanumeric value with the nature of the condition being added with a keyboard. In the first instance, when a stain is identified, the “stain” icon can be pulled from the menu over the stain location. In the second instance, an alphanumeric icon is pulled over the stain location and “stain” or similar comment is keyboarded into the comment area.

The present program may be integrated with known point of sale (POS) software used by framers to calculate the cost of framing artwork as electronically displayed. Generally, known POS systems store the identity and cost of numerous framing components and other materials used in picture framing, such as glass, backing materials, etc. Other cost factors such as labor and the framer's markups are included. This prior art POS software is sometimes used together with framed artwork display software which generates the image from stored electronic images of artwork and framing components. When the user selects the components, the POS software calculates the price to frame the displayed artwork from this information. The POS software can include other modules for customer billing, inventory management, etc.

Since actual framing components are initially used instead of electronically stored component images in the present invention, an additional step is required to identify each of the framing components. While component identifications can be manually added to the computer storage, the program preferably identifies each component by acquiring identifying characteristics from the components. For example, the identifying characteristics may be the RGB values of the mat color. Alternatively, the identifying characteristics may be information available from a barcode or RFID attached to the component.

The acquired identification characteristics are then compared with stored characteristics of a plurality of mats. A match of stored and acquired characteristics serves to identify the mat for pricing purposes, etc. If there is more than one possible match, the possible matches may be displayed for manual selection of the preferred match by the user. If there are no matches, the user can manually input the identification of the mat into storage.

Component identifications can also be used to generate surrounds from stored images of the framing components instead of from the photographic images of the components. In this alternative, images of a plurality of components are stored in the database. When a match with the photographed image is found, the stored database image is used to create the surround of that component. This alternative may provide a higher quality image, if the stored images are of a higher quality than the photographed image.

Upon selection of an acceptable combination of framing components and artwork, the image of the artwork with surrounds can be stored for future reference along with the original image of the artwork and the image of the original artwork with indicators of the artwork condition.

### BRIEF DESCRIPTION OF THE DRAWINGS

FIG. 1 is a plan view of a template for positioning artwork and framing components at predetermined locations.

FIG. 2 is a perspective view of the template of FIG. 1 with a digital camera positioned above the template.

FIG. 3 is a front view of a computer and monitor with a screen displaying a representation of artworks surrounded by selected framing components.

FIG. 4 is a schematic illustration of the computer components.

FIG. 5 is a representation of a GUI for use in recording artwork condition information.

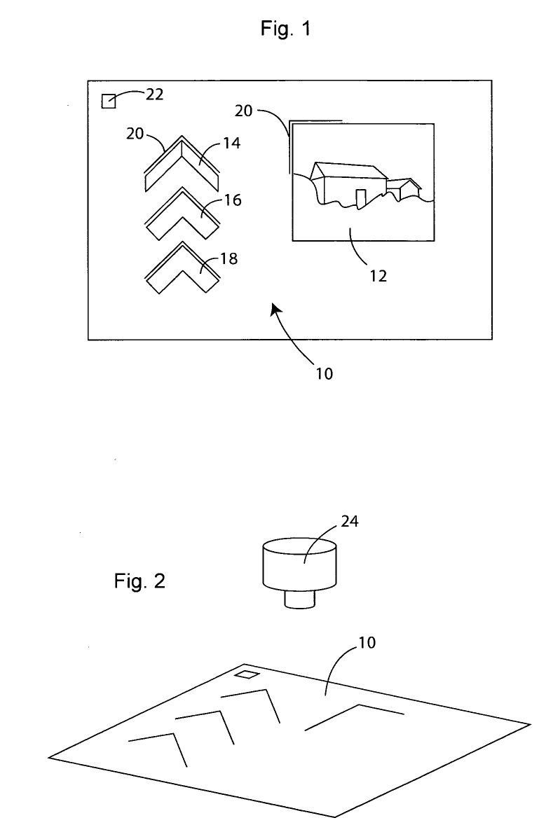

### DETAILED DESCRIPTION OF THE INVENTION

In the following description, terms such as horizontal, upright, vertical, above, below, beneath, and the like, are used solely for the purpose of clarity in illustrating the invention, and should not be taken as words of limitation. The drawings are for the purpose of illustrating the invention and are not intended to be to scale.

The present system is comprised of a template, generally 10, illustrated with artwork 12, moulding corner sample 14, top mat corner sample 16 and bottom mat corner sample 18 positioned adjacent alignment markers 20 on template 10. Each alignment marker 20 can be specifically reserved for the artwork or a given type of framing component. In that case, the item within the “moulding” location will be recognized by the computer program as the moulding, and the item within the “top mat” location will be recognized as the top mat. Alternatively, the software program can be designed to automatically recognize the components by other features, such as their colors, sizes or shapes. In that case, either component can be aligned adjacent either of the positioning guides. Template 10 also includes a calibration mark 22 of known dimensions, e.g., 1 inch square, for determining the relative dimensions of artwork 12 and framing components 14, 16 and 18.

The system further includes a digital camera 24, and a computer 26 that includes a processor 36, and memory 38 with the installed computer program. Computer 26 communicates with monitor 28, shown displaying a graphical image of artwork 12 within computer generated moulding surround 30, mat surround 32 and reveal surround 34. As used herein, a “surround” is a computer generated image of a framing component extending entirely around the artwork.

In selecting framing components, artwork 12 is viewed in the frame shop with actual segments of moulding 14 and mats 16 and 18. Once the customer has selected potential framing components, artwork 12 and framing components 14, 16 and 18 are laid onto template 10 and a photograph taken with digital camera 24 is transferred to memory 38 in computer 26.

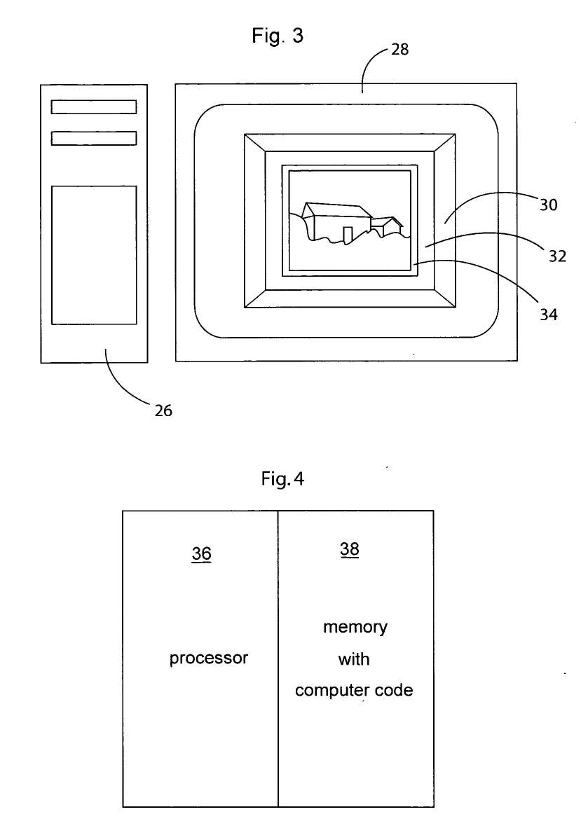

The program code installed in the computer memory and readable by the processor then extracts the required information from the stored photographic image and generates the graphical image shown on monitor 28 in FIG. 3 by the steps of:
a) identifying the artwork and framing components from their features;
b) determining the dimensions of the artwork and components;
c) determining the desired artwork and components dimensions;
d) extracting image information regarding the artwork and components;
e) generating surrounds of the components; and
f) displaying the combined image of the artwork and components surrounds.

The computer program may perform the following additional steps to ensure an accurate representation of the artwork and components:
a) checking the artwork for squareness, i.e., determining that the side edges are parallel and that the top and bottom edges are parallel, and adjusting the artwork image if needed; and
b) checking the alignment of the components on the template for proper positioning and aligning the component images if needed.

The computer program may also identify each of the component by the steps of:
a) acquiring identifying information from the component, e.g., RGB values or information on a barcode or RFID attached to the component; and
b) comparing the identifying information with component identification information stored in a database.

The program may also be used to perform other steps, including:
a) changing the background in response to user input; and
b) recommending mat colors based on colors extracted from the artwork.

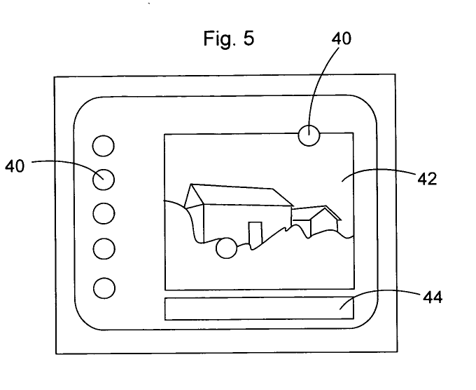

The condition of the photographed artwork can also be recorded using a GUI as represented by FIG. 5, which includes a plurality of icons 40 identifying possible defects in the artwork, e.g., stains, tears, etc., with the icons being moveable over to the locations of the defects on artwork image 42. Icons are shown as condition specific icons, e.g., “T” is a tear icon and “S” is a stain icon, but icons having alphanumeric values can be used. A comment area 44 is provided to add comments with a keyboard.

Upon display of the image, the customer will not only have the advantage of viewing a graphical image of the framed artwork, but will be able to also see the actual components against the artwork with the dimensions of the framing components being adjusted relative to the dimensions of the artwork. Moreover, the framed image will be generated automatically without the need for user selection of segments of each of the components.

Certain modifications and improvements will occur to those skilled in the art upon a reading of the foregoing description. It should be understood that all such modifications and improvements have been deleted herein for the sake of conciseness and readability but are properly within the scope of the following claims.

What is claimed is:

1. A method for displaying a computer generated representation of framed artwork comprising:
a) acquiring an image of said artwork;
b) positioning selected framing components at predetermined locations on a surface;
c) taking a digital photograph of said components;
d) transferring said photograph in computer memory;
e) identifying said components from their features;
f) generating images of component surrounds from said stored photograph; and
g) displaying an electronic representation of said artwork within said component surrounds.

2. The method of claim 1, wherein the image of said artwork image is acquired by positioning said artwork at a predetermined location with said components and taking a photograph of said artwork and said components.

3. The method of claim 1, further including the step of providing a framing template having positioning guides, said components being positioned on said template in accordance with said positioning guides.

4. The method of claim 3, wherein said template includes a calibration mark, said artwork dimensions being calculated based on the relative dimensions of said artwork and said calibration mark.

5. The method of claim 1, wherein said components include a moulding section and at least one mat section.

6. The method of claim 1, further including calculating the price to frame said artwork as displayed based on the sizes of said components and stored cost information.

7. The method of claim 1, further including storing information regarding the condition of said artwork.

8. The method of claim 1, further including storing the identification of said components.

9. The method of claim 1, wherein the dimensions of said surrounds are based on the dimensions of the artwork visible within the components.

10. The method of claim 1, further including changing the color of the background of the electronic representation of the artwork and surrounds.

11. The method of claim 1, further including the step of deskewing said artwork and components.

12. The method of claim 1, further including the step of check said artwork for squareness.

13. A method for identifying framing components comprising:
a) positioning selected framing components at predetermined locations on a surface;
b) taking a digital photographic image of said components;
c) storing said photographic image;
d) acquiring component identification information from said photographic image; and
e) comparing said acquired identification information with stored component identification information.

14. The method of claim 13, wherein said identification information is RGB data.

15. The method of claim 13, wherein said acquired identification information is acquired from a barcode or RFID attached to the component.

16. The method of claim 13, further including the step of providing a framing template having positioning guides, said components being positioned on said template in accordance with said positioning guides.

17. The method of claim 13, further including calculating the price of said components based on said component identification.

18. An apparatus for displaying a computer generated representation of a framed artwork surrounded by selected framing components comprising:
a) a template having positioning indicators for said framing components;
b) a digital camera for taking a photograph of selected framing components positioned on said template;
c) a computer having a processor, memory, a display means, and a user input device; and
d) computer readable code in said memory readable by said processor for generating component surrounds from said photograph and displaying an electronic representation of said artwork within said component surrounds on said display means.

19. The apparatus of claim 18, wherein said template further includes a calibration mark for determining the dimension of said artwork and framing components.

20. The apparatus of claim 18, wherein said computer code is adapted to perform the step of generating surrounds of said framing components from images of said components in said photograph.

21. The apparatus of claim 18, wherein said computer code is adapted to perform the step of storing information regarding the condition of said artwork based on icons placed on an image of said artwork.

22. A computer program product comprising a computer useable medium having computer readable program code embodied therein for automatically generating a graphical representation of framed artwork from a photograph of the artwork and framing components, said program code performing the steps of:
a) identifying framing components from the features of said components in a photographic image of artwork and framing components positioned on a surface;
b) creating surrounds of said components from the images of said components; and
b) displaying a computer generated image of said artwork within said surrounds.

23. The computer program product of claim 22, wherein said program code performs the step of identifying the framing components from their position in the photograph.

24. The computer program product of claim 22, wherein said program code performs the step of identifying the framing components from identifying features selected from colors, sizes, shapes, and combinations thereof.

25. The computer program product of claim 22, wherein said program code performs the step of storing information regarding the condition of said artwork based on icons placed on an image of said artwork.

26. The computer program product of claim 22, wherein said program code performs at least one of the steps of checking the artwork for squareness, checking the alignment of the components on the template for proper positioning and aligning the component images if needed, and determining identifying characteristics of the framing components by comparing the identifying characteristics with recorded identifying information.

27. A method for recording the condition of a stored artwork image comprising:
a) storing a photographic image of said artwork in computer memory;
b) displaying said image on a monitor along with condition indicating icons;
c) positioning said icons on said artwork to indicate the location of defects; and
d) storing said image and positioned icons.

28. The method of claim 27, wherein said icons are condition specific icons.

29. The method of claim 27, wherein said icons are alphanumeric icons.

30. The method of claim 27, wherein further including adding textual comments regarding said artwork condition.
